(19) United States
(12) Patent Application Publication
(10) Pub. No.: US 2014/0068658 A1
(43) Pub. Date: Mar. 6, 2014

(54) ADVERTISEMENT EMBEDDED SYSTEM, ADVERTISEMENT EMBEDDED METHOD, AND RECORDING MEDIUM THEREOF

(71) Applicant: INSTITUTE FOR INFORMATION INDUSTRY, Taipei City (TW)

(72) Inventors: Jing-Fung CHEN, New Taipei City (TW); Chia-Hsiang CHANG, Taipei City (TW); Emery JOU, Taipei City (TW); Pei-Wen HUANG, Taipei City (TW)

(73) Assignee: INSTITUTE FOR INFORMATION INDUSTRY, Taipei City (TW)

(21) Appl. No.: 13/670,169

(22) Filed: Nov. 6, 2012

(30) Foreign Application Priority Data
Aug. 31, 2012 (TW) 101131764

(51) Int. Cl. H04N 21/43

(52) U.S. Cl. CPC H04N 21/43
USPC 725/32

(57) ABSTRACT

An advertisement embedded system, an advertisement embedded method, and a recording medium thereof are provided. The system includes a medium providing module and a digital television (DTV) apparatus. The medium providing module is used to provide a piece of advertisement media data. The DTV apparatus includes a digital signal receiving unit, a detection unit, and a processing unit. The digital signal receiving unit receives a DTV signal, and the detection unit detects strength of the DTV signal. The processing unit is connected to the digital signal receiving unit and the detection unit. When the strength of the DTV signal detected by the detection unit is less than a preset value, the processing unit switches a media source of the DTV apparatus from the digital signal receiving unit to the medium providing module, so as to obtain the piece of advertisement media data.

### CROSS-REFERENCE TO RELATED APPLICATION

This application claims the benefit of Taiwan Patent Application No. 101131764, filed on Aug. 31, 2012, which is hereby incorporated by reference for all purposes as if fully set forth herein.

### BACKGROUND

1. Field of Invention

The present invention relates to an advertisement embedded system, an advertisement embedded method, and a computer recording medium thereof, and more particularly to an advertisement embedded system, an advertisement embedded method, and a computer recording medium thereof capable of providing advertisement media data in time when a digital television (DTV) signal is weak or is interrupted.

2. Related Art

With the popularity of DTVs, requirements for DTV receiving devices such as digital Set Top Boxes (STBs) or DTVs increasingly grow. Generally speaking, the DTV receiving devices are mainly used to perform processing such as filtering, demodulation, demultiplexing, and decompression on received DTV signals, so as to re-establish TV program content broadcasted by a TV station, for users to watch.

At present, in the prior art, advertisement playing manners of the following kinds mainly exist. For example, US patents No. US2007/0250856, U.S. Pat. No. 7,080,078, No. US2006/0253330, and U.S. Pat. No. 7,647,609 disclose a manner of playing the advertisement according to network conditions, but do not provide an advertisement playing manner in a case that a network receiving condition is unstable. In U.S. Pat. No. 6,738,978, the advertisement is played as a common program. U.S. Pat. No. 6,918,084 merely describes an arrangement manner of the advertisement, but does not illustrate when the advertisement is inserted and when the advertisement is played; as for US patent No. US2008/0307454, a digital Internet Protocol Television (IPTV) is designed for advertisement playing, but no solution is provided for a situation when network signals are weak. In addition, the following prior art also exists. U.S. Pat. No. 2,081,264 merely describes a new advertisement highlighting manner with an interval change; U.S. Pat. No. 7,848,765 provides a regional advertisement; and further, in US patent No. US2009/0307732, the advertisement is inserted by detecting an advertisement point. However, the foregoing relevant technical content does not illustrate an advertisement insertion point and relevant content that a channel capable of normally receiving an advertisement is selected to receive the advertisement during advertisement update, as mainly disclosed in the present invention.

Common digital multimedia audio/video data is an audio/video signal completed by combining images, voice, and subtitles. Therefore, the digital multimedia audio/video data provided by the DTV (or the STB) is played for the users to watch after downloading of an audio/video signal of the digital multimedia audio/video data is requested from a server host. However, when each film or program is about to be played, an image signal, a voice signal, and a subtitle signal of the digital multimedia audio/video data need to be transmitted through the network. The file size of the image signal is usually very large, so the downloading of the digital multimedia audio/video data requires considerable network traffic, and occupies a large bandwidth, thereby affecting whole data transmission efficiency; moreover, interruption or weakness of the signal usually occurs, and meanwhile, the user can merely see a stagnant picture or no picture usually.

### SUMMARY

The present invention provides an advertisement embedded system, an advertisement embedded method, and a computer recording medium thereof, so as to switch a source of a digital medium and play advertisement media data when the signal is weak during the transmission of a DTV signal or no signal exists.

The present invention provides an advertisement embedded system, where the system includes: a medium providing module and a DTV apparatus. The medium providing module is used to provide a piece of advertisement media data. The DTV apparatus includes a digital signal receiving unit, a detection unit, and a processing unit, where the digital signal receiving unit receives a DTV signal, and the detection unit detects strength of the DTV signal. The processing unit is connected to the digital signal receiving unit and the detection unit. When the strength of the DTV signal detected by the detection unit is less than a preset value, the processing unit switches a media source of the DTV apparatus from the digital signal receiving unit to the medium providing module, so as to obtain the piece of advertisement media data.

The advertisement embedded method provided by the present invention is as follows: providing a piece of advertisement media data by a medium providing module; receiving a DTV signal by a digital signal receiving unit of a DTV apparatus; detecting the DTV signal by a detection unit; judging, by a processing unit according to the DTV signal, whether strength of the DTV signal is less than a preset value; and switching, by the processing unit, a media source of the DTV apparatus, from the digital signal receiving unit to the medium providing module, so as to obtain the piece of advertisement media data.

The present invention further provides a recording medium, which is provided to an electronic apparatus to perform the foregoing advertisement embedded method. The method is described in the above, and the details are not described herein again.

The features of the present invention lie in that, the strength of the DTV signal is detected, so as to switch the media source and play the corresponding advertisement, so that the user does not need to spend time waiting for the completion of the transmission of the audio/video data; in addition, through the source of obtaining the advertisement media data, the user can select DTV content played by a multimedia playing device according to personal preference, so as to improve precision of obtaining the required advertisement media data; moreover, the user can obtain the required advertisement media data through specific advertisement played content, thereby solving an impatience problem occurring when the user waits for the program playing, and expanding advertisement benefits at the same time.

### BRIEF DESCRIPTION OF THE DRAWINGS

The present invention will become more fully understood from the detailed description given herein below for illustration only, and thus are not limitative of the present invention, and wherein:

FIG. 1 is a perspective block diagram of system elements according to a first embodiment of the present invention;

FIG. 2 is a perspective diagram of a first detailed architecture of an advertisement embedded system according to an embodiment of the present invention;

FIG. 3 is a perspective diagram of a second detailed architecture of an advertisement embedded system according to an embodiment of the present invention;

FIG. 4 shows another advertisement embedded system according to an embodiment of the present invention;

FIG. 5 is a perspective flowchart of an advertisement embedded method corresponding to FIG. 1; and

FIG. 6 to FIG. 8 are perspective detailed flowcharts of the advertisement embedded method according to an embodiment of the present invention.

### DETAILED DESCRIPTION

To make the features and advantages of the present invention more comprehensible, the present invention is described in detail in the following with reference to the specific embodiments and the accompanying drawings.

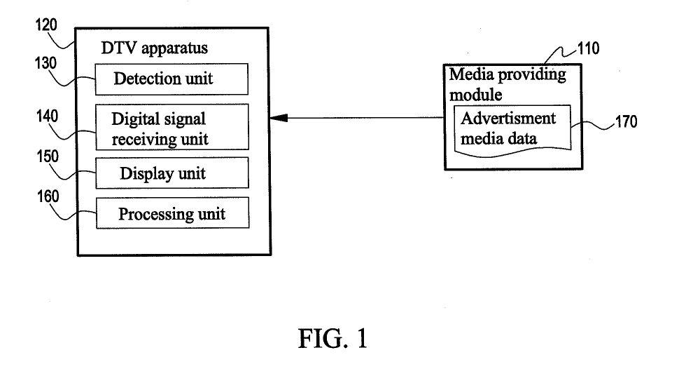

FIG. 1 is a perspective block diagram of system elements according to the present invention. In FIG. 1, an advertisement embedded system is shown, and includes: a medium providing module 110 and a DTV apparatus 120. The medium providing module 110 is used to provide a piece of advertisement media data 170. The DTV apparatus 120 includes a detection unit 130, a digital signal receiving unit 140, a display unit 150, and a processing unit 160.

The digital signal receiving unit 140 receives a DTV signal, the detection unit 130 detects strength of the DTV signal, and the processing unit 160 is connected to the digital signal receiving unit 140 and the detection unit 130. When the strength of the DTV signal detected by the detection unit 130 is less than a preset value, the processing unit 160 switches a media source of the DTV apparatus from the digital signal receiving unit 140 to the medium providing module 110, so as to obtain a piece of advertisement media data 170; and the piece of advertisement media data 170 is displayed through the display unit 150.

The DTV apparatus may be a DTV set having a network connection device, or a combination of a DTV STB capable of connecting to the network and a TV set. The DTV set refers to a TV set capable of directly receiving and processing a foreign DTV signal, or a TV set with a built-in DTV decoder. In the combination of the DTV STB and the TV set, the DTV signal is converted into an analog TV signal by using the DTV STB, so that an analog TV set receives the DTV signal for displaying.

In an embodiment of the present invention, the processing unit 160 further includes a pre-downloading procedure, for pre-downloading a non-played DTV image signal when the DTV signal is weak, and storing the pre-downloaded and non-played DTV image signal in a register unit.

In an embodiment of the present invention, the DTV apparatus 120 further has a built-in digital STB; the detection unit 130, the digital signal receiving unit 140, and the processing unit 160 are disposed in the digital STB. The display unit 150 is a TV set, and the TV set is externally connected to the processing unit 160 of the digital STB. In another embodiment, the DTV apparatus is a DTV set capable of connecting to the network, and includes all the foregoing elements.

The processing unit 160 may be connected to a remote DTV server, for example, an IPTV system, a network connection TV, or Chunghwa Telecom MOD, through a communication network, so as to receive a DTV signal and an original digital text signal.

In this embodiment, the digital signal receiving unit 140 receives, through a wired or wireless network, the DTV signals and the original digital text signals provided by DTV channels of a plurality of digital wireless TV stations, for example, TTV, CTV, CTS, FTV, and PTS.

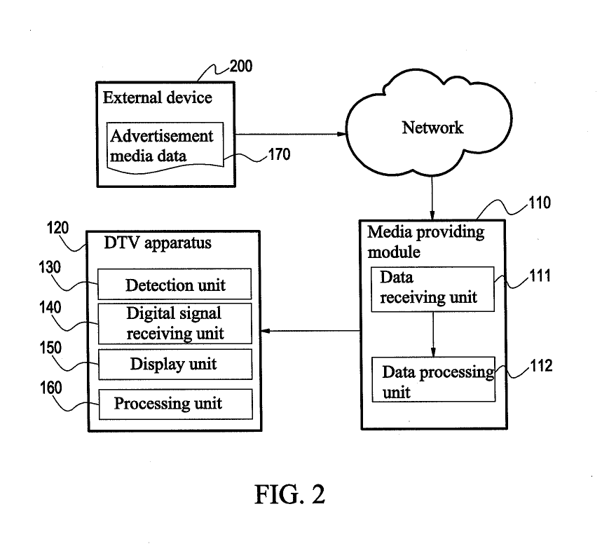

FIG. 2 is a perspective diagram of a first detailed architecture of the advertisement embedded system according to an embodiment of the present invention. In this embodiment, a medium providing module 110 includes a data receiving unit 111 and a data processing unit 112. The data receiving unit 111 itself is not stored with advertisement media data 170. The data receiving unit 111 adopts the following media providing mode: the data receiving unit 111 is connected to an external device 200 directly/indirectly through a digital signal receiving unit to receive a signal sent by a local broadcast station, or receive the signal through a network such as Internet or a local channel, so as to obtain the advertisement media data 170 and provide the obtained advertisement media data 170 to a DTV apparatus 120. The obtained advertisement media data 170 may be streaming media or whole audio/video data.

When the advertisement media data 170 is the streaming media, the data processing unit 112 directly transmits a received media frame or media clip to the DTV apparatus 120. If the advertisement media data 170 is the whole audio/video data, the data processing unit 112 provides the advertisement media data 170 to the DTV apparatus 120 after completion of receiving the advertisement media data 170.

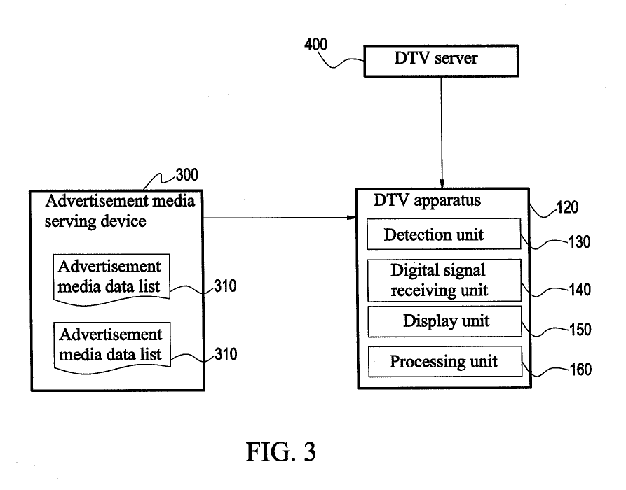

FIG. 3 is a perspective diagram of a second detailed architecture of the advertisement embedded system according to an embodiment of the present invention. Difference between FIG. 3 and FIG. 2 lies in that, an advertisement media serving device 300 is connected to a DTV apparatus 120 in a wired or wireless connection manner; moreover, an advertisement media data list 310 is provided by the advertisement media serving device 300. In this embodiment, the advertisement media serving device 300 may be a third-party device. Moreover, the advertisement media data list included in the advertisement media serving device 300 may be provided after other users perform the same or similar multimedia source switching operation through software or hardware related to, similar to, or equivalent to the multimedia source switching technologies disclosed by the present invention.

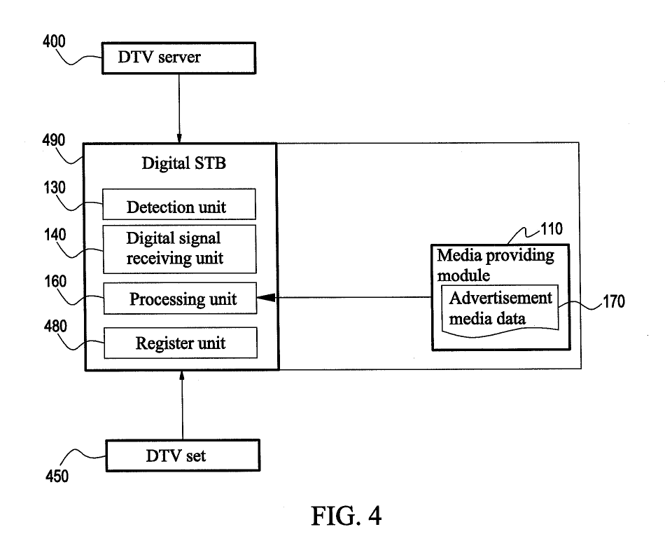

FIG. 4 is a perspective block diagram of system elements according to a second embodiment of the present invention. In FIG. 4, a further actual application of the advertisement embedded system is shown, and in this embodiment, the system includes: a medium providing module 110, a DTV server 400, a DTV set 450, and a digital STB 490, where the digital STB 490 may be built in the DTV set 450 or is electrically connected to the DTV set 450 in an external connection manner.

The medium providing module 110 is built in the digital STB 490, and is used to provide a piece of advertisement media data 170. The digital STB 230 receives, through a digital signal receiving unit 140, a DTV signal delivered from the DTV server 400 or digital antenna broadcast, and the signal is played through the DTV set 450. Manners of receiving the DTV signal are roughly classified into the following kinds:

1. voice signal: for example, a radio digital signal sent by an AM/FM radio station or transmitted through Voice over Internet Protocol (VoIP);

2. broadcast: for example, a digital signal sent from a wireless TV station or a regional digital signal, where the regional digital signal refers to a signal sent from a regional wireless TV station or a local TV station; and

3. data transmission: a coverage in this transmission manner is wide, and the DTV signal may be subdivided into a video signal, an image, and a text/subtitle/context, which are obtained from Internet such as youtube or a managed network (for example, Chunghwa Telecom MOD or VoD), where currently, the video signal may be transmitted in a multimedia streaming manner or in a transmission manner combining two or more manners, so that the user can more smoothly and fluently watch the video.

At this time, the detection unit 130 continuously detects strength of the DTV signal downloaded by the DTV server 400. When the processing unit 160 determines that the strength of the downloaded DTV signal is less than a preset value or no signal exists, the processing unit 160 switches a media data source, so that the DTV set 450 plays the advertisement media data 170 in the medium providing module 110. The digital STB 490 is further disposed with a register unit 480, so as to store the pre-downloaded and non-played DTV image signal.

In this embodiment, the processing unit 160 further includes a pre-downloading procedure capable of pre-downloading the non-played DTV image signal when the strength of the DTV signal is less than a preset value or no signal exists, and storing the pre-downloaded signal in the register unit 480, to accumulate the signals into a film clip, and then the film clip is played through the DTV set 450. The detection unit 130, the digital signal receiving unit 140, the processing unit 160, and the register unit 480 are disposed in the digital STB 490; while the DTV set 450 is connected to the processing unit 160 of he digital STB 490.

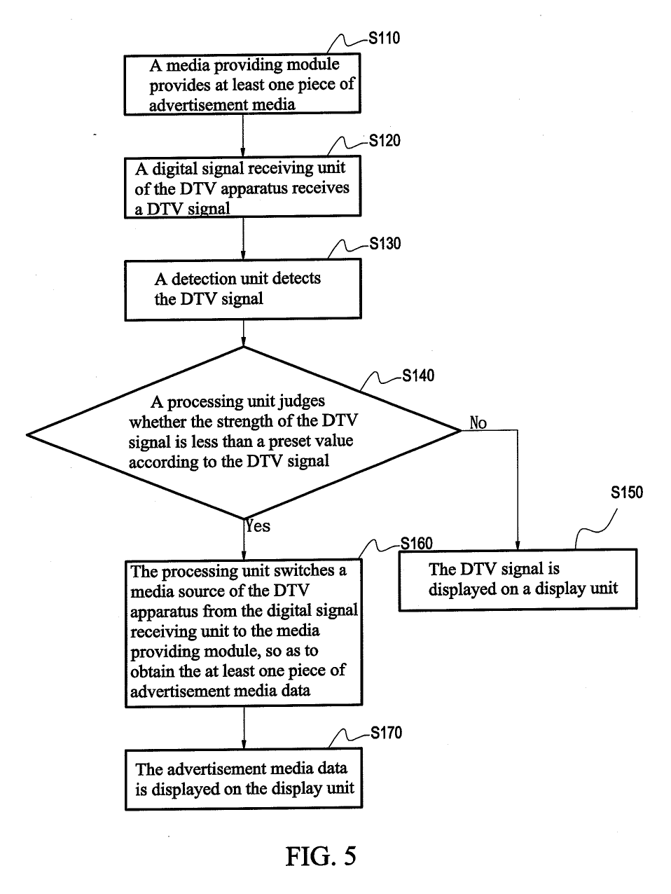

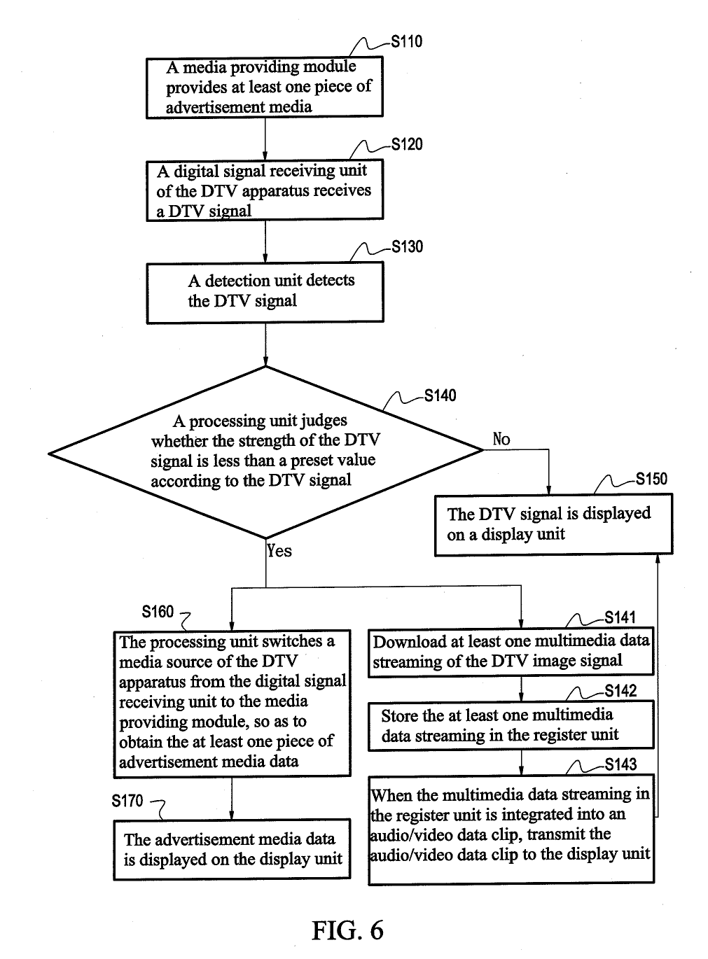

FIG. 5 is a perspective flowchart of an advertisement embedded method corresponding to FIG. 1, and FIG. 6 to FIG. 8 are perspective detailed flowcharts of the advertisement embedded method according to an embodiment of the present invention. For ease of understanding, reference is made to FIG. 1 to FIG. 4. FIG. 5 is a flowchart of steps according to an embodiment of the present invention. In FIG. 5, the main steps are as follows.

In step S110, a medium providing module 110 provides a piece of advertisement media data 111. Detailed implementation manner of this step varies according to different manners of providing the advertisement media data 170. As shown in FIG. 2, the medium providing module 110 is connected to an external device 200, the external device 200 supplies the advertisement media data 170, and the medium providing module 110 is merely used as an intermediary for receiving and forwarding the data. The detailed implementation manner of this step is shown in FIG. 8, which is as follows: a data receiving unit 111 of the medium providing module 110 receives the externally transmitted advertisement media data 170 (step S111), and then the medium providing module 110 provides the advertisement media data 170 to a DTV apparatus 120 (step S119).

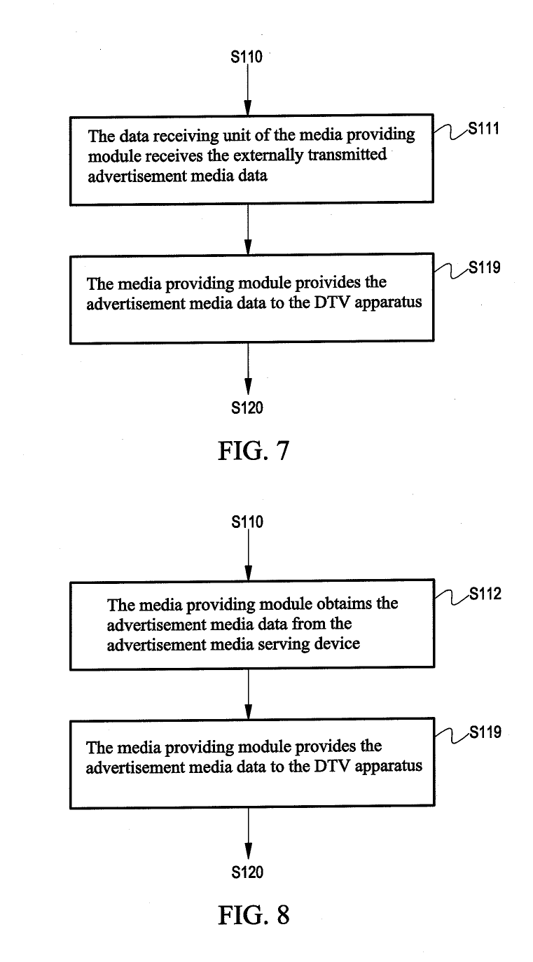

As shown in FIG. 3, an advertisement media serving device 300 is connected to the DTV apparatus 120. The detailed implementation manner of this step is shown in FIG. 8, but different from the flow shown in FIG. 7 in that, in step S112, advertisement media data lists 310 are stored in the advertisement media serving device 300 serving as a third-party network device. The medium providing module 110 provides the advertisement media data 170 to the DTV apparatus 120 (step S119).

In step S120, a digital signal receiving unit of the DTV apparatus receives a DTV signal, where the digital signal receiving unit 140 receives, through a wired or wireless network, DTV signals or original digital text signals provided by DTV channels of a plurality of digital wireless TV stations, for example, TTV, CTV, CTS, FTV, and PTS.

In step S130, a detection unit detects the DTV signal, where the strength of the digital signal is affected by factors such as time, landform, and bandwidth, so the digital signal is not maintained at fixed signal strength and may be changed at any time.

In step S140, a processing unit judges whether the strength of the DTV signal is less than a preset value according to the DTV signal, and if yes, step S160 is performed; otherwise, step S150 is performed.

In step S150, the DTV signal is displayed on a display unit, that is, the display unit plays a film or program content generally watched.

In step S160, the processing unit switches a media source of the DTV apparatus from the digital signal receiving unit to the medium providing module, so as to obtain a piece of advertisement media data.

In step S170, the advertisement media data is displayed on the display unit, and is played through the display unit.

At the same time, the processing unit further performs a pre-downloading procedure. As shown in FIG. 4, the medium providing module 110 provides the advertisement media data 170. The medium providing module 110 merely serves as an intermediary for receiving and forwarding the data, and the processing unit 160 stores the pre-downloaded DTV signal in a register unit 480. The detailed implementation manner of this step is shown in FIG. 6, which is as follows: a multimedia data streaming of the DTV image signal is downloaded (step S141); the multimedia data streaming is stored in the register unit 480 (step S142); when the multimedia data streaming in the register unit 480 is integrated into an audio/video data clip, the audio/video data clip is transmitted to the DTV set 450 (step S143), and the DTV signal is displayed on the display unit, that is, the display unit plays a film or program content generally watched (step S150).

To sum up, the advantages of the present invention lie in that, by using a network connection mechanism and according to the strength of the DTV signal in time, the content played by the DTV apparatus is switched. Since the instant message of the DTV signal and the digital text signal on the STB is generally a short text message, the text message may be instantly translated and transmitted back to the DTV apparatus through the system and the method of the present invention, and is synchronously played with the DTV signal. In addition, in the translation mechanism provided by the present invention, pre-processing before the translation may be performed for unknown words and ambiguous words usually occurring during the translation of the instant message, thereby achieving an instant translation effect.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An advertisement embedded system, comprising:
a medium providing module, used to provide a piece of advertisement media data; and
a digital television (DTV) apparatus, comprising:
a digital signal receiving unit, for receiving a DTV signal;
a detection unit, for detecting strength of the DTV signal; and
a processing unit, connected to the digital signal receiving unit and the detection unit, wherein when the strength of the DTV signal detected by the detection unit is less than a preset value, the processing unit switches a media source of the DTV apparatus from the digital signal receiving unit to the medium providing module, so as to obtain the piece of advertisement media data.

2. The advertisement embedded system according to claim 1, wherein the processing unit further comprises a pre-downloading procedure, for pre-downloading a non-played DTV image signal when the DTV signal is weak.

3. The advertisement embedded system according to claim 2, wherein the DTV apparatus further comprises a register unit, so as to store the pre-downloaded and non-played DTV image signal.

4. The advertisement embedded system according to claim 1, wherein the DTV apparatus further comprises a network connection device, so that the DTV apparatus is connected to a DTV server through the network connection device, so as to obtain the DTV signal.

5. The advertisement embedded system according to claim 1, wherein the DTV apparatus further has a built-in digital Set Top Box (STB), and the medium providing module, the digital signal receiving unit, and the processing unit are disposed in the digital STB.

6. The advertisement embedded system according to claim 5, wherein the DTV apparatus further comprises a display unit, the display unit is a TV set, and the TV set is externally connected to the processing unit in the digital STB.

7. The advertisement embedded system according to claim 1, wherein the DTV apparatus is a DTV set capable of connecting to a network.

8. The advertisement embedded system according to claim 1, wherein the digital signal receiving unit receives, through a wired or wireless network, the DTV signal provided by a plurality of wireless TV stations.

9. The advertisement embedded system according to claim 1, wherein the medium providing module comprises a data receiving unit, for receiving externally transmitted media data, so as to provide the media data to the DTV apparatus.

10. The advertisement embedded system according to claim 9, further comprising an advertisement media serving device, connected to the medium providing module, wherein when the medium providing module provides the advertisement media data, the media data corresponding to the advertisement media data is obtained from the advertisement media serving device, so as to provide the advertisement media data to the DTV apparatus.

11. The advertisement embedded system according to claim 1, wherein the digital signal receiving unit receives the DTV signal broadcasted and sent through a DTV antenna.

12. The advertisement embedded system according to claim 1, wherein the digital signal receiving unit receives a digital broadcast signal broadcasted and sent from an FM/AM radio station.

13. The advertisement embedded system according to claim 1, wherein the digital signal receiving unit receives the DTV signal sent from a network serving device.

14. An advertisement embedded method, comprising the following main steps:
providing, by a medium providing module, a piece of advertisement media data;
receiving, by a digital signal receiving unit of a digital television (DTV) apparatus, a DTV signal broadcasted and sent through a DTV antenna;
detecting, by a detection unit, the DTV signal;
judging, by a processing unit according to the DTV signal, whether strength of the DTV signal is less than a preset value; and
switching, by the processing unit, a media source of the DTV apparatus from the digital signal receiving unit to the medium providing module, so as to obtain the piece of advertisement media data.

15. The advertisement embedded method according to claim 14, further comprising the following step:
performing, by the processing unit, a pre-downloading procedure, to pre-download a non-played DTV image signal.

16. The advertisement embedded method according to claim 14, wherein the performing a pre-downloading procedure further comprises the following steps:
downloading a multimedia data streaming of the DTV image signal;
storing the multimedia data streaming in a register unit; and
when the a multimedia data streaming in the register unit is integrated into an audio/video data clip, transmitting the audio/video data clip to a display unit.

17. The advertisement embedded method according to claim 14, further comprising the following steps:
outputting, by an operating unit, a channel setting signal;
playing, by the DTV apparatus according to the channel setting signal, a DTV signal of a selected channel; and
when the operating unit outputs the channel setting signal, performing a pre-downloading procedure corresponding to the selected channel.

18. The advertisement embedded method according to claim 14, wherein the step of providing, by a medium providing module, piece of advertisement media data comprises:
receiving, by a data receiving unit of the medium providing module, the externally transmitted advertisement media data; and
providing, by the medium providing module, the advertisement media data to the DTV apparatus.

19. The advertisement embedded method according to claim 14, wherein the step of providing, by a medium providing module, a piece of advertisement media data comprises:
obtaining media data and the advertisement media data from a database of the medium providing module; and
providing the media data and the advertisement media data to the DTV apparatus.

20. The advertisement embedded method according to claim 19, wherein the step of providing, by a medium providing module, a piece of advertisement media data comprises:
obtaining, by the medium providing module, the advertisement media data corresponding to the media data from an advertisement media data serving device; and
providing, by the medium providing module, the media data and the advertisement media data to the DTV apparatus.

21. A recording medium, storing a program code capable of being read by an electronic device, wherein when the electronic device reads the program code, the electronic device performs an advertisement embedded method, and the method comprises the following steps:
providing, by a medium providing module, a piece of advertisement media data;
receiving, by a digital signal receiving unit of a digital television (DTV) apparatus, a DTV signal;
detecting, by a detection unit, the DTV signal;
judging, by a processing unit according to the DTV signal, whether strength of the DTV signal is less than a preset value; and
switching, by the processing unit, a media source of the DTV apparatus from the digital signal receiving unit to the medium providing module, so as to obtain the piece of advertisement media data.

22. The recording medium according to claim 21, wherein the step of providing, by a medium providing module, a piece of advertisement media data comprised in the method comprises:
continuously receiving, by a data receiving unit of the medium providing module, externally transmitted advertisement media data; and
providing the advertisement media data to the DTV apparatus.

23. The recording medium according to claim 21, wherein the step of providing, by a medium providing module, media data and a piece of advertisement media data comprised in the method comprises:
obtaining, by the medium providing module, the advertisement media data from an advertisement media data serving device; and
providing, by the medium providing module, the advertisement media data to the DTV apparatus.
